(19) United States
(12) Patent Application Publication
(10) Pub. No.: US 2002/0131496 A1
(43) Pub. Date: Sep. 19, 2002

(54) System and method for adjusting bit rate and cost of delivery of digital data

(76) Inventors: Vinod Vasudevan, Foster City, CA (US); Steven Rand, Bellmont, CA (US)

Correspondence Address: MORRISON & FOERSTER LLP, 3811 VALLEY CENTRE DRIVE, SUITE 500, SAN DIEGO, CA, 92130-2332, US

(21) Appl. No.: 09/886,398

(22) Filed: Jun. 20, 2001

Related U.S. Application Data
(63) Continuation-in-part of application No. 09/761,770, filed on Jan. 18, 2001.

(51) Int. Cl. H04N 7/12

(52) U.S. Cl. 375/240.11

(57) ABSTRACT

This invention provides an adaptive transcoder that modifies a data stream for transmission over variable bandwidth networks and to devices having varying processing capabilities in accordance with client desired bit rates. In order to modify the bit rate of a data stream, in a preferred embodiment, certain frames of the data stream are replaced with Pseudo-P frames according with the results of frame ranking techniques.

### RELATED APPLICATIONS

This application is a continuation-in-part of U.S. Application Ser. No. 09/761,770, entitled “System and Method For Adaptive Streaming Of Predictive Coded Video Data,” filed on Jan. 18, 2001 and commonly assigned with the present application.

### FIELD OF THE INVENTION

This invention relates generally to methods and systems for transmitting digital data, such as streaming of video data and, more specifically, to a method and system for providing adaptive transmission of digital data at variable packet rates in accordance with client-requested packet rates and/or delivery costs.

### BACKGROUND OF THE INVENTION

Conventional methods for streaming video send a static, i.e., constant bit-rate stream of video data to all devices connected to a network. Such methods fail to adjust the bit-rate to the needs or desires of a client, a receiving device, or a network. For example, when a video stream is sent to a client device at too high a bit-rate, the network may become congested and, as a result, drop packets. Or, the client may not have sufficient processing power to decode all the frames that are sent to it and therefore, it may drop some of the frames, which results in distortion of the display. The distortion may be in the form of, for example, pauses or gaps in the display. Therefore, it may not be possible to send a bit stream at one particular rate to all devices connected to a network since different devices have different processing capabilities and different bandwidths available to them. Nor is it is efficient to send a static bit-rate stream to all devices connected to a network.

In addition to the above device or network bandwidth considerations, a client may consider the cost of delivery as an important criteria in determining how data should be transmitted. With the proliferation of the internet and wireless internet technologies, the number of clients, devices and networks capable of receiving digital data, such as streaming video, has grown tremendously and it is envisioned that this number will continue to grow at an extremely rapid pace. In addition to the technical bandwidth limitations of the various types of devices and networks, it is contemplated that commercial limitations such as the cost of delivering digital data will be an important factor affecting how data-delivery service providers offer their services and how clients receive and utilize those services. For example, one market model envisioned is that clients will be charged based on two criteria: (1) content and (2) quality (e.g., rate) of delivery. In such a market, it would be desirable and advantageous to allow a client to choose not only the content that he or she will receive but also the rate at which such content will be received depending on such factors as: cost, the technical limitations of the client's receiving device or network, the importance or purpose of the content being received, etc. Prior methods and systems do not address or provide this choice to the client.

Some of these prior methods and systems simply send a single (i.e., static) bit-rate stream to all devices connected to a network. However, such systems are extremely inefficient because they require that the bit-rate of the static stream be in accordance with the network capabilities of the device having the lowest bandwidth capacity. Thus, other network devices having higher bandwidths will be inefficiently underutilized. To overcome the problems associated with sending a static bit-rate stream to devices having various bandwidths, conventional methods for streaming video store multiple versions of an encoded stream at multiple bit-rates and send an appropriate version of the stream to each client device, depending on the bandwidth of the client device. This conventional manner of video streaming is illustrated in FIGS. 1A and 1B. Creating and managing multiple versions of encoded video, however, is redundant, time consuming, complex, and costly.

FIG. 1A depicts a conventional method for streaming a pre-coded video stream to multiple clients that may operate according to different bandwidth capabilities. The video stream is pre-encoded into multiple streams, each at a predefined and fixed bit-rate, and stored on a server. Each client receives a video stream at a bit-rate that is suitable for its bandwidth and the server sends an appropriate stream at one of the stored bit-rates to the client. These prior systems detect available bandwidth by using one or two techniques. In a first technique, the systems receive information about stream data that was dropped by the network from the client and hence can estimate whether the data rate being sent to the client is too high. In a second method, when a client first connects to a server, the client tells the server the type of connection it has (e.g., 28.8 Kbps modem, 56 kbps modem, cable or T1) and the server chooses the appropriate stream encoded a priori at different bit rates.

FIG. 1B depicts a conventional method for transmitting a live stream of video data to multiple clients. The video stream is simultaneously passed through multiple encoders, and each of the encoders is dedicated to processing a stream at a particular bit-rate. The set of encoders thus reflects a range of fixed, discrete bit-rates. Each encoder encodes the stream at its predefined bit-rate and transmits the stream to a server. As with coded video, the server streams multiple bit-rate copies of the stream and sends the appropriate stream to the client at a bit-rate indicated by the client.

An additional problem associated with static bit-rate streams arises in dynamic allocation bandwidth networks in which the bandwidth varies throughout the network. In dynamic allocation bandwidth networks, the available bandwidth varies according to, for example, the amount of traffic on the network at a particular time. For instance, if the bandwidth of a network is 56 kbps, the available bandwidth for the client will vary dynamically according to the traffic on the network path from the client to the server. If there is less traffic, the client can access more bandwidth and vice versa. Thus the client is likely to experience bandwidth fluctuations. In such a network, a constant bit-rate video stream is unable to change its transmission rate to match that of the network. Rather, it continues to transmit at a static bit-rate, failing to take advantage of more bandwidth when available and, more importantly, causing breaks and distortion in a video display when the available bandwidth falls below a required bandwidth. To deal with networks where the bandwidth varies dynamically, conventional methods for video streaming encode a video stream by either reducing the frame resolution and/or degrading the quality of a frame. Other conventional methods deal with dynamic bandwidth allocation problems by indiscriminately dropping packets of data at regular intervals.

Accordingly, a need exists for a more efficient manner of streaming both pre-coded and live video in dynamic bandwidth networks and to devices having various processing capabilities. This manner of streaming should also accord with the capabilities of non-error resilient streaming methods, such as MPEG. A further problem with current methods and networks which deliver digital data is that clients have no choice of how they want their data delivered to them and at what cost. Therefore, there is a need for a method and system capable of delivering data at a rate and cost desired by the user.

### SUMMARY OF THE INVENTION

This invention provides a system and a method to adaptively transcode predictive coded video data and associated audio data such that the data may be transmitted at a bit-rate that matches a bit rate or delivery cost requested by a client. The invention not only allows clients to request desired bit rates and delivery costs but also alleviates some of the burdens on service providers for determining how to best transmit digital data to its clients, taking into consideration factors such as the client's desires, the quality of the data transmission and available bandwidth. Additionally, by providing client's the option of receiving data a reduced or more economical bit rates, the invention promotes conservation of network bandwidth. Furthermore, through the use of the novel transcoding techniques disclosed herein, the invention provides optimal transmission quality (with minimal loss of content), even at reduced bit rates that may be desired by clients, by automatically distinguishing important elements of the data content from less important elements, and “dropping” the less important elements first. As used herein, the term “transcode” refers to transforming and coding a data stream so as to adjust its bit rate. Predictive coded video data refers to a stream of video data including multiple frames that have been encoded at a specific bit rate. This system and method can be used to transmit video according to a variety of streaming techniques, including, for example, MPEG.

In accordance with an embodiment of the invention, a method for transmitting data streams to a client is provided. The method includes receiving a client input indicative of a desired bit rate for delivery of a data stream, analyzing the video data stream to determine characteristics of the stream, transcoding the data stream to provide a transcoded data stream having a bit rate substantially equal to the desired bit rate, and transmitting the transcoded data stream to the client.

In a further embodiment, the method further includes determining an available bandwidth for transmission of the data stream to a particular client, and, if the available bandwidth is insufficient to allow transmission of the data stream at the desired bit rate, determining a second bit rate capable of being transmitted by the available bandwidth and transcoding the data stream to provide a transcoded data stream having a bit rate substantially equal to the second bit rate. In one embodiment, the transcoding process includes analyzing the characteristics of the data stream, identifying coded frames of the data stream that can be replaced with corresponding replicating frames that replicate previously decoded frames, i.e., frames that have already been decoded, replacing the coded frames with their corresponding replicating frames to produce the transcoded data stream, and transmitting the transcoded data stream to the client.

In accordance with another embodiment of the invention, a method for transmitting an audio/video data stream to a client is provided. The method includes receiving an audio/video data stream, analyzing the audio/video data stream to determine characteristics of the stream, separating the audio/video data into an audio data stream and a video data stream, determining an available bandwidth for transmission of the video data stream to a particular client, determining, according to the characteristics of the video data stream and the available network bandwidth, a coded frame of the stream that can be replaced with a replicating frame that replicates a previously decoded frame, replacing the coded frame with the replicating frame to produce a modified video data stream, and transmitting the modified video data stream and the audio data stream to the client.

In accordance with another embodiment of the invention, a method for adaptive transcoding of video data is provided. The method includes receiving a stream of video data, receiving client input data indicative of a desired bit rate, and, based on the desired bit rate, creating a modified stream of video data by replacing a frame with a previously encoded frame which replicates a previously decoded frame. In a further embodiment, the method further determines an available bandwidth of a network and/or client device for transmitting the stream of video data to the client and modifying the stream of video data based on the available bandwidth, if the desired bit rate is too high to be handled by the available bandwidth.

In accordance with yet another embodiment of the invention, a system to transcode predictive coded video data is provided. The system includes a content analysis and description system that analyzes the stream of video data to determine characteristics of the stream, a frame ranker subsystem that assigns a numerical rank to each frame included in the stream of video data, a rate control subsystem that determines an available bandwidth of a network and/or client device for transmitting the stream of video data to the client, a memory for storing a client's desired bit rate for delivery of the video data, and a transcoder subsystem that modifies the stream of video data to accord with the available bandwidth by replacing a frame with a previously encoded frame which replicates a previously decoded frame according to a frame rank so as to transmit a modified stream of video data to the client at the desired bit rate stored in the memory.

In accordance with still another aspect of the invention, a method for adaptive streaming of predictive coded video data that includes a sequence of frames is provided. The method includes receiving a stream of video data, analyzing the stream to determine characteristics of the stream, determining a desired bit rate for transmission of the stream, transcoding the video data by determining, according to the characteristics of the stream and the desired bit rate, at least one frame that can be replaced with a frame that replicates a previously decoded frame and replacing the frame with the frame that replicates the previously decoded frame to produce a modified stream having a bit rate substantially equal to the desired bit rate, and transmitting the modified stream to the particular client.

### BRIEF DESCRIPTION OF THE DRAWINGS

FIG. 1A depicts a conventional method for streaming a pre-coded video stream to multiple clients that may have different bandwidth capabilities.

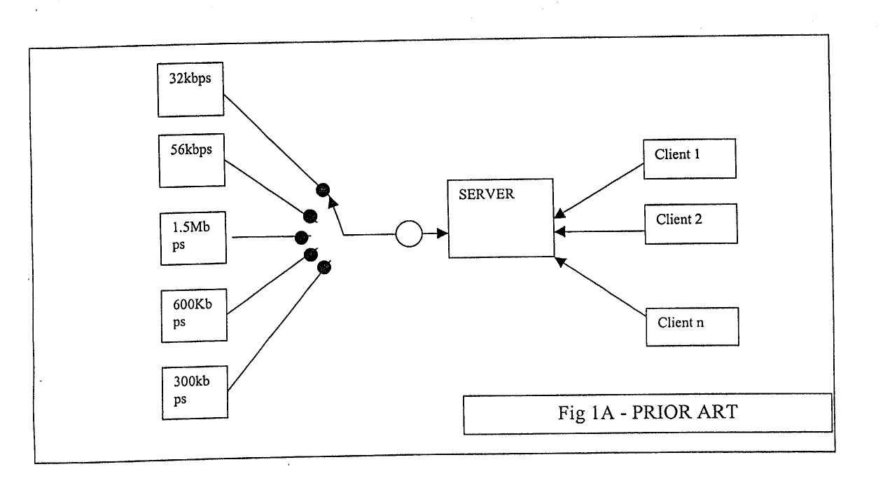

FIG. 1B depicts a conventional method for streaming a live stream of video data to multiple clients.

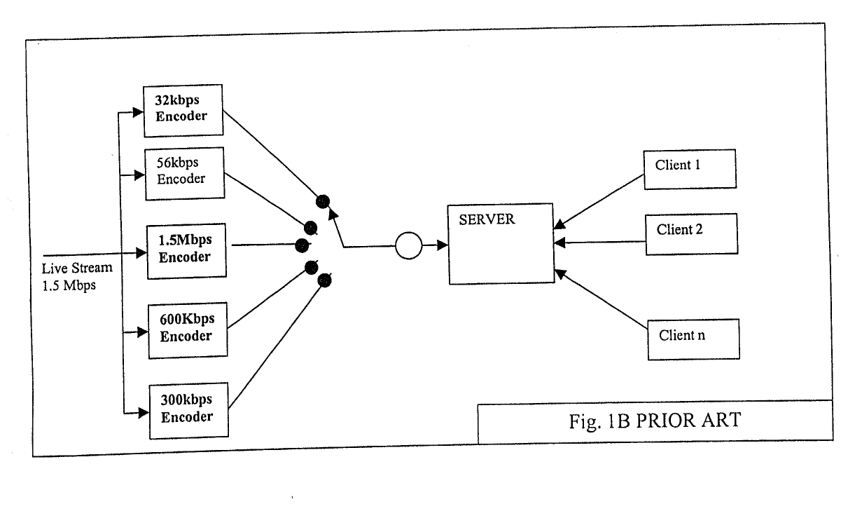

FIG. 2 depicts an illustrative overview block diagram of a presently preferred embodiment of the invention.

FIG. 3 depicts an illustrative block diagram of a more detailed view of an embodiment of this invention.

FIG. 4 depicts an illustrative structure of a Pseudo-P frame.

### DETAILED DESCRIPTION OF THE INVENTION

The following description is presented to enable any person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art would realize that the invention may be practiced without the use of these specific details. In other instances, well-known structures and devices are shown in block diagram form in order not to obscure the description of the invention with unnecessary detail. Thus, this invention is not intended to be limited to the embodiment shown, but is to be accorded the widest scope consistent with the principles and features disclosed herein.

A current embodiment of the invention provides an adaptive analysis and transcoding system (“adaptive transcoder”) which streams video over variable bandwidth networks and to devices having varying processing capabilities. The invention dynamically and continuously determines a client's available network bandwidth and transmits a single MPEG stream, altering it to meet the needs of various client devices without adding redundancy into a network. In one embodiment, the system dynamically modifies a data stream to suit the available bandwidth amount and, thus, dynamically alters the packet rate in accordance with the packet protocol of the network and/or client device. This is because the data stream is typically packetized before it is sent to a client on the network. Therefore, if the system modifies the stream to drop to a lower bit rate, fewer packets are required to send the lower bit rate data during any given time frame. To do this, the system uses frame rate manipulation and rate control mechanisms to transmit multiple streams, possibly at different bit rates, to multiple devices on the network. Therefore, the system of the invention does not require multiple encoders to stream live video and does not require pre-coding and storage of a data stream at various bit-rates for on demand video. The term “transcode,” as used herein refers to transforming and coding a data stream.

In particular, the invention uses bit stream transcoding of video and audio data to adapt the bandwidth required to transfer a data stream. To decrease the bit-rate of a stream, the frame rate manipulation and rate control subsystems determine which frames can be replaced with frames replicating previously decoded frames. Thus, for example, in an MPEG-1 stream certain frames are replaced with Pseudo-P frames, which replicate a previously decoded frame. To further lower the bandwidth requirement, the audio portion of a signal can be also transcoded. In particular, the audio portion of the stream can be re-encoded into a lower bit-rate stream by, for example, reducing the sampling rate of the audio signal, using a coarser quantization, using stereo to mono conversion, or a combination of these and other known methods. According to any of these methods, re-encoding the audio portion of the stream into a lower bit-rate may include, for example, decoding the stream, sampling the bit-rate of the decoded stream, and encoding the stream.

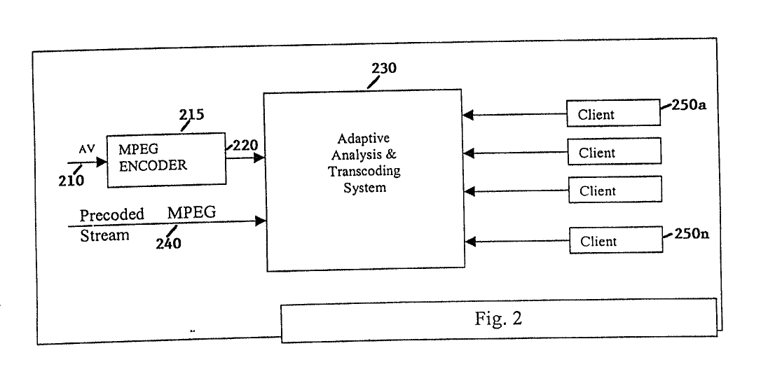

FIG. 2 depicts an illustrative overview block diagram of one embodiment of the invention. As depicted in FIG. 2, a live audio/video data stream 210 is sent to a MPEG encoder 215 that encodes the stream. The MPEG encoder 215 sends the encoded stream 220 to an adaptive transcoder 230 of the invention. Alternatively, a precoded MPEG stream 240, such as a previously stored stream, is sent directly to the adaptive transcoder 230. Client devices 250a . . . 250n indicate to the adaptive transcoder 230 a desired bit-rate of the stream. Of course, the client may indicate the desired bit rate in several alternate ways. For example, the client may specify a desired cost for receiving the data stream, or a desired viewing format (e.g., slide show, real-time video, etc.) which is ultimately translated by the system into a bit rate choice. Thus, what is specified by the client may be of a qualitative nature and not necessarily an explicit bit rate choice. The system of the invention receives the client's request and maps this qualitative value, or cost value, to an explict bit rate according to arbitrary but meaningful criteria. An example of a client “indication” may be a choice from three stream price plans such as “free, cheap, or elite.” These may be mapped by the server to “28.8 kbps, 56 kbps and 128 kbps,” respectively, for example. Considering both the bit rate requested by the clients and the actual available bandwidth of the network as calculated by the adaptive transcoder 230 and/or rate control unit 330 (explained in further detail below), the adaptive transcoder 230 transmits a bit stream at an appropriate rate to each client device 250a . . . 250n.

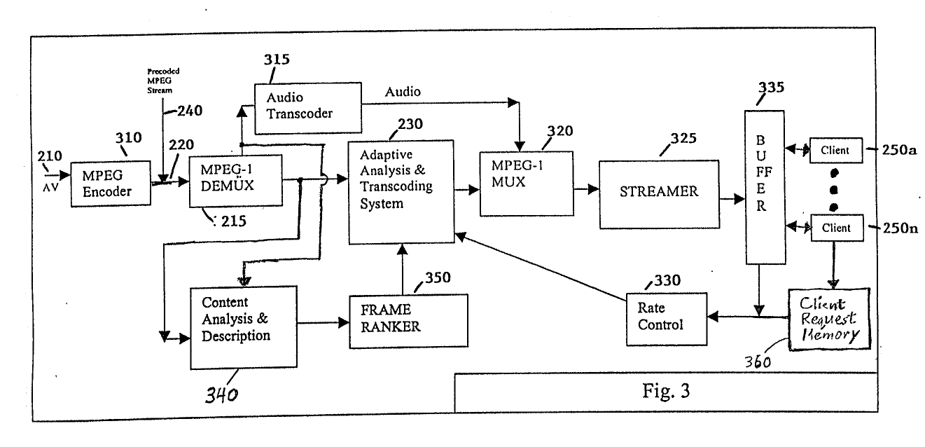

FIG. 3 depicts an illustrative block diagram of one embodiment of the invention. The system of FIG. 3 includes a MPEG encoder 310, a MPEG demultiplexer 215, an audio transcoder 315, a content analysis and description subsystem 340, an adaptive video transcoder 230, a frame ranker subsystem 350, a MPEG multiplexer 320, a data streamer 325, a rate control subsystem 330 and a buffer 335. It is understood that the block diagram of FIG. 3 is intended to illustrate the overall functionality of the system of the invention, in accordance with one embodiment. Each of the blocks can represent a device, circuit, component or software module, or any combination thereof, which is either well-known in the art or which could be easily designed and implemented by those skilled in art to perform the functionality described herein.

As shown in FIG. 3, a live incoming audio/video stream 210 is sent to a MPEG encoder 310 which encodes the stream 210 and provides an encoded MPEG stream 220 to the MPEG demultiplexer 215. Alternatively, as shown in FIG. 3, if the incoming data stream is a precoded MPEG stream 240, the MPEG encoder 310, may be bypassed, and the precoded MPEG stream 240 is sent directly to the MPEG demultiplexer 215. As is known in the art, the MPEG stream 220 or 240 contains MPEG video and audio packets. This stream also contains other information used to identify, route and/or correlate the video and audio packets such as, for example, time code information which may be used to correlate the video and audio packets.

In a preferred embodiment, the MPEG encoder 310 encodes the stream 210 at the highest bit-rate capable of being received by a prospective client. The MPEG demultiplexer 215 separates the encoded audio/video stream 220, 240 into corresponding audio and video streams, and sends the audio data to the audio transcoder 315 and sends the video data to the adaptive transcoder 230. The MPEG demultiplexer 215 further simultaneously sends the audio and video packets, along with any other required information (e.g., time code information) to the content analysis and description unit 340.

The audio transcoder 315 receives the audio packets from the MPEG demultiplexer 215 and converts the audio bit-rate as described above, for example, by changing the sampling frequency or by stereo-to-mono conversion. The audio transcoder 315 then sends the transcoded audio data to MPEG multiplexer 320.

In one preferred embodiment, the adaptive transcoder 230 receives the video data from the MPEG demultiplexer 310 and creates a bandwidth adaptive video bit stream by replacing I, P, or B frames, as appropriate, with Pseudo-P frames, in order to lower the bit-rate of the video stream to a desired rate, as described in further detail below. The adaptive transcoder 320 then sends each client 250a . . . 250n a specific bit-rate data stream that corresponds with an amount of available bandwidth on a particular network during a given time interval. Alternatively, the specific bit-rate transmitted by the adaptive transcoder 320 will correspond to a specific bit rate or delivery cost requested by one or more of the clients 250. In a preferred embodiment, as described in further detail below, a user 250 can specify a desired bit-rate or, alternatively, a cost of delivery, and the system will deliver the data stream at a corresponding bit-rate, subject, of course, to any bandwidth limitations of the network and/or client device. For example, if a user 250 desires to receive a complete video stream (e.g., one complete movie or show) at an economy rate or price (e.g., $5.00), the system will deliver the video stream at a bit-rate corresponding to the economy price (e.g., 56 Kbps) even though the client's network or device would be capable of receiving the video stream at a higher rate. Conversely, if the available bandwidth of the network and/or client device, is not large enough to handle a desired rate or delivery cost specified by the user, e.g., in times of heavy network traffic, the system dynamically adjusts the video stream bit rate so as to fully utilize the available bandwidth as much as possible, with minimal loss of content.

In order to decrease the bit rate of a data stream with minimal loss of content, an analysis of the content and characteristics of the stream is performed. The content analysis and description subsystem 340, which corresponds to a conventional content and analysis description module, receives audio and video packets from the MPEG demultiplexer 215 and determines various features of the stream, including, for example, audio and video activity measures, speaker changes, and a function of a frame, such as, shot boundary frames, key frames, scene change frames, etc. Video activity may be determined, for example, according to a number of motion vectors in each frame. The following table depicts an exemplary output of the content and analysis description subsystem 340. In this table, the feature values included in the third column correspond to: 0—no feature; 1—shot boundary frame; 2—key frame.

| Time | Frame Number | Feature |
|---|---|---|
| 24099689400 | 1000000 | 1 |
| 24099689539 | 1000001 | 2 |
| 24099689638 | 1000002 | 2 |
| 24099689668 | 1000003 | 2 |
| 24099689694 | 1000004 | 2 |
| 24099689748 | 1000005 | 2 |
| 24099690062 | 1000006 | 2 |
| 24099690465 | 1000007 | 0 |
| 24099690513 | 1000008 | 2 |
| 24099690628 | 1000009 | 2 |
| 24099690744 | 1000010 | 2 |
| 24099690817 | 1000011 | 2 |
| 24099690867 | 1000012 | 2 |
| 24099691104 | 1000013 | 2 |
| 24099691252 | 1000014 | 1 |
| 24099691636 | 1000015 | 0 |

The content analysis description subsystem 340 sends the analysis information (i.e., the feature values) to the frame ranker subsystem 350 which determines an importance of each frame as an integer and assigns the integer to the frame as an indicator of a rank of the frame based on the feature value of the frames and other rules described below. The rank of a frame indicates the importance of the frame. For example, frames that correspond to changes in a scene of a video stream are marked as important frames and are assigned higher numerical ranks than other frames. The rank of the frame is computed as a function of the features of the stream in the neighborhood of the frame, i.e., the rank of each frame is determined according to the feature of the frame and is therefore a function of the features of the frame. Thus, each feature is assigned a rank, ranging from 0 to 5, with 0 being the highest rank and 5 being the lowest rank. The frames corresponding to the most important features are assigned the highest rank and the lesser important frames are assigned a lower rank. Thus, for example, whenever the feature is a “shot boundary frame,” the rank may be set to 0 indicating that the frame is important.

To determine an appropriate rank for each frame, the frame ranker subsystem 350 applies a set of rules. The rules may vary according to the type of video data being streamed. Thus, for example, the rules applied when streaming a news video may differ from the rules applied when streaming a video of a sporting event.

In determining a rank for a current frame, the rules consider extracted features of both the current frame and the previous frame that was ranked. Following is an exemplary set of rules that can be used to determine a rank of a previous frame:

(1) Assign a default rank to the frame as follows: if frame is a shot boundary frame, then rank=2, OR if frame is a key frame then rank=3, OTHERWISE rank=4.

(2) If the frame contains text OR if the previous frame was blank OR if the frame contains crowd noise then rank=rank−1.

(3) If the frame contains a graph OR contains a text change OR if the previous frame corresponds to silence then rank=0.

(4) If the previous frame contained text and the frame contains text but no text change then rank=rank+1.

(5) If the features of the previous frame are identical to the features of the frame AND neither the previous frame nor the frame contain text AND the time interval between the frames is less than a threshold time (e.g., 1 second) then rank of previous frame=(rank of previous frame+1).

(6) Convert ranks of frame and previous frame into the range 0 to 5.

(7) Transmit rank of previous frame and mark the current frame as the previous frame.

In one embodiment, the above rules are used to process and rank each frame in a video stream. However, one of skill in the art will appreciate that the above rules for processing are exemplary only and that processing may vary depending on the type of data being streamed in accordance with different rules emphasizing different criteria.

After assigning a rank to a frame, the frame ranker 350 passes the ranked frames to the adaptive transcoder 230. In a preferred embodiment, the adaptive transcoder 230 uses the frame rank to determine which frames should be replaced with “Pseudo-P” frames, described further below. Frames having higher numerical ranks, i.e., more important frames, will not be replaced by Pseudo-P frames. In a preferred embodiment, ranks are paired to frame numbers. These frame numbers may be generated identically by the content analysis and description unit 340 and the adaptive transcoder 230. In one embodiment, the transcoder 230 knows which frame the analyzer is referring to, by counting frames coming out of the demultiplexer 215. In another embodiment, using MPEG time code information contained in the packetized elementary stream, the adaptive transcoder 230 correlates a frame rank with the packets corresponding to that frame received from the MPEG demultiplexer 215. Various techniques and schemes for correlating data packets with frame rank information are well-known in the art and can easily be implemented in accordance with the present invention.

Once the adaptive transcoder 230 and audio transcoder 315 code their respective data streams, the audio and video streams are transmitted to a MPEG multiplexer 320. The multiplexer 320 combines the two streams (audio and video) and outputs a single stream to a conventional data streamer 325. The streamer 325 then transmits the data stream to a client 250a . . . 250n via an output buffer 335. Since some of the data frames are now Pseudo-P frames, as described above, the actual bit rate of the data stream received by a client is adaptively decreased. The data streamer 325 performs many of the client's housekeeping activities including, for example, connection start-up, connection termination, and reconnection when a connection is interrupted. Additionally, the streamer 325 maintains all state information on a per client basis, including buffer allocation. Thus, buffer multiplexing is unnecessary as buffers may be allocated and deallocated at will, provided adequate system resources are available. The system of the invention sends a data stream to each client which has been dynamically adjusted too match the bit rate requested by each client. Each client data stream bit rate is dynamically adjustable by modifying a single original stream encoded at a single bit rate.

The system of FIG. 3 further includes a user request memory 360 for storing user input values such as desired bit rates and/or delivery costs for a particular video stream. Through the use of appropriate user interface software executed by a processor (e.g., CPU) (not shown) of the system, a user may be prompted to specify a desired bit rate or delivery cost for a particular data stream. For example, in one embodiment, the user's device (e.g., desktop computer or wireless device) is provided with a menu of various data content with available bit rates and/or delivery costs for each content. When a user picks the desired content and bit rate and/or delivery cost, the user's choices are transmitted to the server (not shown) of the system and stored in the user request memory 360. A user interface program for providing a menu display and receiving user option choices from the menu, as described above, is easily implemented by one of ordinary skill in the art, without undue experimentation. The user request memory 360 may be any suitable memory or storage device known in the art for storing information (e.g., RAM, buffers, etc.).

The rate control system 330 reads a client's request from the user request memory 360 and then notifies the adaptive analysis and transcoding system 230 of the appropriate bit rate for a desired data stream. Based on the bit rate specified by the rate contral system 330, the transcoding unit 230 adaptively adjusts the bit rate of the video data stream as discussed above and provides the adapted video data stream to MPEG multiplexer 320 which combines the video data stream with the transcoded audio data stream received from the audio transcoder 315. This adapted audio/video stream is then provided to the streamer unit 325.

In one embodiment, if the bit rate requested by a client (or bit rate corresponding to a requested delivery cost) exceeds the bandwidth capability of the network and/or client device, the system of the present invention either notifies the client that there is insufficient bandwidth capacity and/or transmits the data stream at a maximum bit rate capable of being handled by the network and client device, with minimal loss of content. This is similar to a default functionality when a client does not specify any desired bit rate or delivery cost. In such cases, the system of the invention transmits the data stream at a maximum bit rate capable of being handled by the network and client device, with minimal loss of content. When a client's requested bit rate is lower than the bandwidth capacity of the network and/or the client's receiving device, the system adaptively reduces the bit rate, as necessary, to the requested bit rate with minimal loss of content, as described above.

In order to determine the bandwidth capacity of the network or client device(s), the rate control system 330 monitors the “fullness” of the buffer 335 (as indicated by the amount of data in the buffer at a given time), estimates the bandwidth capability of each client, i.e., the bandwidth available to each client, and instructs the adaptive transcoder 230 to adjust the bit-rate of the stream according to the bit rate requested by a particular client or a bandwidth available to the client. Thus, the rate control subsystem 330 controls the bit-rate at which data is streamed to a particular client 250a . . . 250n. It determines whether any clients have requested a specific bit rate and/or cost of delivery and further determines the available bandwidth to the particular client according to the amount of data included in the buffer 335.

In one embodiment, the rate control system 330 substantially continuously or periodically (e.g., every 5 seconds) determines, i.e., estimates the rate at which data is being streamed to a client 250a . . . 250n, for example, as follows:

At an instant of time “t”, an amount of data contained in the buffer 335 can be determined according to the following equation

bₜ=bₜ₋₁+(Rᵢₙ−Rₒᵤₜ)Δt

Where,

Rᵢₙ is the input Rate

Rₒᵤₜ is output Rate

bₜ is the amount of data in the buffer at time t

bₜ₋₁ is the amount of data in the buffer at time (t−1)

Δt is time interval between time “t” and time “(t−1)”

According to this equation, we determine an output rate of the buffer as follows:

Rᵢₙ−Rₒᵤₜ=(bₜ−bₜ₋₁)/Δt

Rₒᵤₜ−Rᵢₙ−(bₜ−bₜ₋₁)/Δt

The above equations indicate an amount of data in the buffer at time t, which in turn indicates an estimate of the bandwidth that is available to a particular client. This estimated value is used by the adaptive transcoder 230 to generate a stream to be transmitted to a client at a particular bit-rate.

Consider the following example: Suppose a stream of predictive coded video data is transmitted at a rate of 30 Kbytes per second. A buffer of size 256 K is receiving a stream of data at a rate of 12 Kbytes per second and a client is reading from the buffer at a rate of 10 Kbytes per second. According to this invention, Pseudo P-frames are needed to replace a number of frames such that the bit-rate is reduced by at least 2 Kbytes per second so that there is no overflow in the buffer. As described above, the frame rank of the received frames indicates which frames will be replaced. The resulting video display will thus not look as natural as a video in which no frames are being replaced with Pseudo-P frames. The video display may look more like a slide show, which includes some still pictures, than a congruous video. Similarly, if a client device is reading from the buffer at a rate of 24 Kbytes per second, a fewer number of frames need to be replaced with Pseudo-P frames. Thus, the resulting video display is more natural, i.e., closer to a full motion video, than a display resulting from the replacement of frames with Pseudo-P frames.

Further details of how the adaptive transcoder 230 determines which frames to replace with Pseudo-P frames are now provided. An MPEG stream consists of I, P and B type frames. I frames, or “intra” frames, are spatially compressed frames. P frames, or “predicted” frames, are predicted from I frames or other P frames using motion prediction. B frames, or “bidirectional” frames, are interpolated between I and P frames. I, P and B frames are well-known in the art and need not be further described herein. P frames achieve a bit reduction of approximately fifty percent from their corresponding I frames. B frames achieve bit reduction of approximately seventy-five percent from their corresponding I frames. Actual bit reduction differs according to the content of a picture and the mix of I, P, and B frames in the stream and various other settings for spatial compression. For example, if a stream includes a large number of B frames, then replacing some of the B frames with Pseudo-P frames would greatly reduce the bit-rate of the stream. In the invention, whenever there is reduction in available bandwidth, which is detected and fed back to the invention by the rate controller, the invention retains as many as possible of the most important frames that can be transmitted at the reduced bandwidth, and replaces some of the less important frames with Pseudo-P frames, according to the frame rank that is assigned to each frame in a bit stream by the frame ranker subsystem 350. During frame replacement, since the B-coded frames achieve a greatest bit reduction they are replaced first. Since the arrangement of I, P and B frames is determined by an MPEG encoder, the frame ranks are independent of whether the frame is a I, P or B frame. However, there may be correlations between them for various reasons. In one embodiment, these correlations (if any) do not effect the frame ranking process. One of ordinary skill in the art, however, can easily develop different rules for frame ranking which take at least some or all of these correlations into account. It is intended that the scope of the invention covers such modifications of the frame ranking rules.

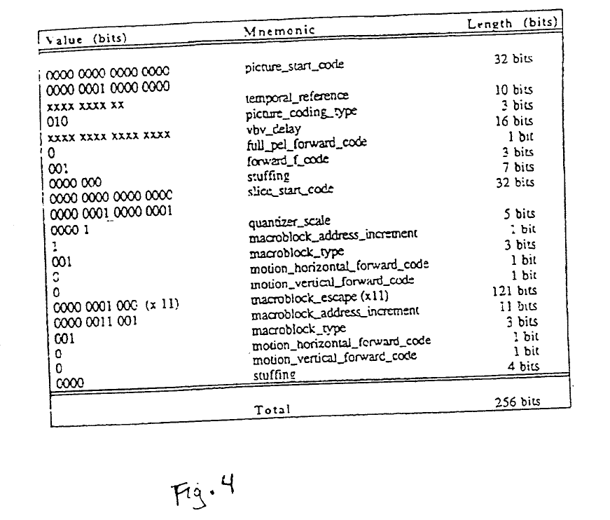

FIG. 4 depicts an illustrative Pseudo-P frame. As depicted in FIG. 4, each Pseudo P-frame is coded with only a few bits. Thus, the impact of a Pseudo P-frame on display of video stream is nearly instantaneous. A Pseudo-P frame replaces a current frame and replicates a previous decoded (and displayed) frame. A Pseudo P-frame thus causes the previous frame to be re-shown. More specifically, during the instant that a Pseudo-P frame replaces a B frame, there is no motion in the video. The Pseudo-P frames use the MPEG coding scheme but essentially contain no video data. Rather, they are data frames that instruct the decoder on the client device to continue showing the previous frame for the duration of time that the frame which the Pseudo-P frame replaces was to be shown. If the bandwidth reduces further, a Pseudo-P-frame also replaces the P frame. In the case of very low bandwidth, a Pseudo-P frame may also replace an I frame. This method of frame replacement allows replacement of either only a B frame with a Pseudo-P frame or allows bit-rate reduction by replacing a P frame and a B frame, which depends on the P frame from which the B frame was interpolated, with Pseudo-P frames. However, because replacing only the P frames of a stream with Pseudo-P frames affects each of the B frames that depend on those P-frames, Pseudo-P frames cannot be used to replace only P-frames. Rather, if a P-frame is replaced with a Pseudo P-frame, the B frame which depends from the P-frame is also replaced with a Pseudo P-frame. Thus, the less bandwidth that a client has available, the slower the resulting video display, creating a slideshow effect. When a client has greater bandwidth capabilities, the resulting video display is closer to that of a full motion video. Therefore, this invention allows the resulting bit stream to be scaled from full motion video to a slide show kind of bit stream.

As depicted in FIG. 4, each Pseudo P-frame includes 256 bits. By replacing an I, P, or B frame with a Pseudo P-frame, the 256 bits of the Pseudo P-frame cause the previous frame to be redisplayed, generating a repeat display of a specific picture.

The frame ranker subsystem determines which of the I, P, or B frames should be replaced with Pseudo P-frames. As described above, the frame ranker subsystem 350 determines the importance of each frame and represents it as a numerical rank. This frame rank is used by the adaptive transcoder 230 to determine which frames should be replaced with Pseudo-P Frames. For example, a frame representing a scene change is more important than a key frame in a shot and is thus assigned a higher frame rank. Therefore, if the bandwidth available to a particular client is low, some of the key frames may be replaced with Pseudo-P frames but all of the scene change frames are retained. Now if a client has a slightly higher available bandwidth both the scene change frames and the key frames may be retained while the other frames are replaced with Pseudo-P frames. Similarly if the frame ranker 350 assigns frames carrying text or a graph, a higher rank than other types of frames, when the bandwidth falls low, the graph and text frames will be retained and other frames may be replaced by Pseudo-P frames. Such rules are applied to the features extracted by the content analysis and description system, and combinations of these features to determine which frames to retain and which to replace.

One of ordinary skill in the art will appreciate that the above description is exemplary only and that the invention may be practiced with modifications or variations of the techniques disclosed above. Those of ordinary skill in the art will know, or be able to ascertain using no more than routine experimentation, many equivalents to the specific embodiments of the invention described herein. Such equivalents are encompassed by the following claims.

What is claimed is:

1. A method for transmitting data streams to a client, comprising:
receiving input data from said client, said input data indicative of a desired bit rate for delivery of a data stream;
analyzing the data stream to determine at least one characteristic of the stream;
transcoding the data stream, based on said at least one characteristic and said desired bit rate, to provide a transcoded data stream having a bit rate substantially equal to the desired bit rate; and
transmitting the transcoded data stream to the client.

2. The method of claim 1 wherein said input data comprises a desired delivery cost specified by said client, said method further comprising determining said desired bit rate from said desired delivery cost.

3. The method of claim 1 further comprising:
determining an available bandwidth for transmission of said data stream to said client; and
if the available bandwidth is insufficient to allow transmission of the data stream at said desired bit rate, determining a second bit rate capable of being transmitted by the available bandwidth, wherein said step of transcoding said data stream provides a transcoded data stream having a bit rate substantially equal to the second bit rate instead of said desired bit rate.

4. The method of claim 3 wherein said step of determining an available bandwidth comprises monitoring an output buffer to determine an output bit rate of said buffer wherein said output bit rate indicates said available bandwidth.

5. The method of claim 1 wherein said data stream comprises a predictive coded video data stream and said step of transcoding comprises:
analyzing said predictive coded video data stream to determine at least one characteristic of the video data stream;
identifying at least one frame of the video data stream that can be replaced with a corresponding replicating frame, said replicating frame being substantially identical to a previously decoded frame; and
replacing the at least one frame with its corresponding replicating frame.

6. The method of claim 5 wherein:
said step of analyzing said predictive coded video data stream comprises categorizing a plurality of frames of said predictive coded video data into a plurality of frame types; and
said step of identifying at least one frame of the video data stream comprises ranking said plurality of frames in accordance with their frame type; and
said step of replacing the at least one frame comprises first replacing those frames ranked as less important than other frames, prior to replacing said other frames.

7. A method for transmitting a video data stream to a client, comprising:
receiving a stream of video data;
receiving client input data indicative of a desired bit rate based on said desired bit rate, creating a modified stream of video data having a bit rate substantially equal to said desired bit rate; and
transmitting said modified video data stream to said client.

8. The method of claim 7 wherein said step of creating a modified stream comprises replacing at least one frame of the video data stream with a previously encoded frame, said previously encoded frame replicating a previously decoded frame.

9. A system for transmitting a data stream to a client, comprising:
a content analysis and description unit that analyzes said data stream to determine at least one characteristic of the stream;
a frame ranker unit that ranks each frame contained within the data stream;
a memory for storing a client's input data indicative of a desired bit rate;
a rate control unit for retrieving said input data from said memory; and
a transcoder unit that modifies the data stream so as to provide a modified data stream having a bit rate substantially equal to said desired bit rate.

10. The system of claim 9 wherein said rate control unit further determines an available bandwidth of a network used to transmit said data stream.

11. The system of claim 9 wherein said transcoder unit modifies said data stream by replacing at least one frame with a previously encoded frame, said previously encoded frame replicating a previously decoded frame, in accordance with frame ranking data received from said frame ranker unit.

12. The system of claim 9 wherein said data stream comprises an MPEG video data stream and said transcoder unit provides a modified MPEG video data stream having a bit rate substantially equal to said desired bit rate.

13. The system of claim 2 wherein said data stream further comprises an audio data stream and said system further comprises:
a demultiplexer for receiving said data stream and separating the stream into said audio data stream and said video data stream; and
an audio transcoder unit for receiving said audio data stream and encoding the audio data stream to reduce its bit-rate, wherein said audio data stream provides audio content for said MPEG video data stream.

14. The system of claim 13 further comprising a multiplexer that combines said encode audio data stream and said modified MPEG video data stream into a single data stream.

15. The system of claim 14, further comprising a streamer that transmits said single data stream to a client device.

16. The system of claim 15 further including an output buffer to hold at least a portion of said single data stream prior to transmission to said client device.

17. The system of claim 16, wherein said rate control unit determines an output data rate of said output buffer to determine an available bandwidth of a network used to transmit said single data stream.

18. A system for adaptively transmitting data streams to a client, comprising:
means for receiving input data from said client, said input data indicative of a desired bit rate for delivery of a data stream;
means for analyzing the data stream to determine at least one characteristic of the stream;
means for transcoding the data stream, based on said at least one characteristic and said desired bit rate, to provide a transcoded data stream having a bit rate substantially equal to the desired bit rate; and
means for transmitting the transcoded data stream to the client.

19. The system of claim 18 wherein said input data comprises a desired delivery cost specified by said client, said system further comprising means for determining said desired bit rate from said desired delivery cost.

20. The system of claim 18 further comprising:
means for determining an available bandwidth for transmission of said data stream to said client; and
means for determining a second bit rate capable of being transmitted by the available bandwidth if the available bandwidth is insufficient to allow transmission of the data stream at said desired bit rate, wherein said means for transcoding said data stream provides a transcoded data stream having a bit rate substantially equal to the second bit rate instead of said desired bit rate.

21. The system of claim 20 wherein said means for determining an available bandwidth comprises means for monitoring an output buffer to determine an output bit rate of said buffer wherein said output bit rate indicates said available bandwidth.

22. The system of claim 18 wherein said data stream comprises a predictive coded video data stream and said means for transcoding comprises:
means for analyzing said predictive coded video data stream to determine at least one characteristic of the video data stream;
means for identifying at least one frame of the video data stream that can be replaced with a corresponding replicating frame, said replicating frame being substantially identical to a previously decoded frame; and
means for replacing the at least one frame with its corresponding replicating frame.

23. The system of claim 22 wherein:
said means for analyzing said predictive coded video data stream comprises means for categorizing a plurality of frames of said predictive coded video data into a plurality of frame types; and
said means for identifying at least one frame of the video data stream comprises means for ranking said plurality of frames in accordance with their frame type; and
said means for replacing the at least one frame comprises means for first replacing those frames ranked as less important than other frames, prior to replacing said other frames.

24. A system for transmitting a video data stream to a client, comprising:
means for receiving a stream of video data;
means for receiving client input data indicative of a desired bit rate
means for creating a modified stream of video data having a bit rate substantially equal to said desired bit rate; and
means for transmitting said modified video data stream to said client.

25. The system of claim 24 wherein said means for creating a modified stream comprises means for replacing at least one frame of the video data stream with a previously encoded frame, said previously encoded frame replicating a previously decoded frame.
